(19) United States
(12) Patent Application Publication
(10) Pub. No.: US 2026/0192478 A1
(43) Pub. Date: Jul. 9, 2026

(54) MOTORIZED TABLE SAW FENCE

(71) Applicant: Emaximus LLC, Corvallis, OR (US)

(72) Inventors: Kingston Steele, Corvallis, OR (US); Jeffrey Paul Hadaway, Roseburg, OR (US)

(21) Appl. No.: 19/439,292

(22) Filed: Jan. 3, 2026

Related U.S. Application Data
(60) Provisional application No. 63/741,783, filed on Jan. 3, 2025.

(51) Int. Cl. B27B 27/10; B27B 27/02

(52) U.S. Cl. CPC B27B 27/10; B27B 27/02

(57) ABSTRACT

An automated table saw fence retrofit system that is controlled with a touchscreen and motor. Instead of manually locking/unlocking, moving, and confirming the fence is set to the correct position, the fence allows users to simply input onto a device a desired width of a wooden board that is to be cut, and then watch the device move accurately into the correct position. This allows craftsmen to work significantly faster when they need to make successive cuts of differing widths. It also helps them avoid mistakes from cutting incorrectly, which wastes time and valuable wood. The system comprises a carriage-fence assembly including a rip fence that extends across a horizontally oriented surface of a table saw, and that is connected to a carriage that is movably mounted on a rail. A motor positioned within the fence may drive a pinion gear that directly engages a rack connected to the rail.

### CLAIMS OF PRIORITY

This patent application claims priority from:
(1) U.S. provisional patent application number 63/741,783, entitled ‘Motorized table saw fence’, filed Jan. 3, 2025.

The application is incorporated by reference herein in its entirety.

### FIELD OF TECHNOLOGY

This disclosure relates generally to a retrofittable motorized movable fence for a table saw.

### BACKGROUND

Table saws are essential tools in woodworking, used for making precise cuts in various materials. A critical component of a table saw is the fence, which serves as a guide to ensure straight and accurate cuts. Table saw fences typically are moveable along a guide rail that is bolted along one side of the table saw. An operator can slide the fence back and forth along the guide rail and then lock the fence in place by means of a locking handle. Many such table saws are sold in a design that requires manual adjustment of the fence—the user will typically need to confirm the width using a tape measure, unlock the fence, adjust it, lock it, and then reconfirm the measurement.

### SUMMARY

An automated table saw fence retrofit system that is controlled with a touchscreen and electric motor. Instead of manually locking/unlocking, moving, and confirming the fence is set to the correct position, the fence allows users to simply input onto a keypad or touchscreen a desired width of a wooden board that is to be cut, and then watch the device move accurately into the correct position. This allows craftsmen to work significantly faster when they need to make successive cuts of differing widths. It also helps them avoid mistakes from cutting incorrectly, which wastes time and valuable wood.

The system may comprise a substantially rectangular and elongate fence, a rail fixed in position at a front edge of a table saw and spanning a length of the table saw, and a carriage physically connected to, and disposed on an underside of, the fence. A motor may be disposed within a front portion of the fence, and a control system may be positioned within the front portion of the fence configured to actuate the motor configured to turn a pinion gear through a shaft that extends through an opening of the carriage.

### BRIEF DESCRIPTION OF THE DRAWINGS

Figures are illustrated by way of example and are not limited to the accompanying drawings, in which, like references indicate similar elements.

FIG. 1 is an illustration of a front perspective view of an automated table saw fence retrofit system.

FIG. 2 is a schematic diagram of a top view of an automated table saw fence retrofit system, shown with its intended operational environment.

FIG. 3 is a schematic diagram of a cut-away side view of an automated table saw fence retrofit system.

FIG. 4 is an illustration of a bottom view of an automated table saw fence retrofit system.

FIG. 5 is a flowchart of a method for retrofitting a table saw fence.

FIG. 6 is a flowchart of a method for operating a table saw fence.

FIG. 7 is a schematic diagram of a table saw fence control system.

### DETAILED DESCRIPTION

Although the present has been described with reference to specific examples, it will be evident that various modifications and changes may be made without departing from their spirit and scope. The modifications and variations include any relevant combination of the disclosed features. Equivalent elements, materials, processes or steps may be substituted for those representatively illustrated and described herein. Certain structures and features may be utilized independently of the use of other structures and features. In addition, the components shown in the figures, their connections, couplings, relationships, and their functions, are meant to be exemplary only, and are not meant to limit the examples described herein.

An automated table saw fence retrofit system that is controlled with a touchscreen and electric motor. Instead of manually locking/unlocking, moving, and confirming the fence is set to the correct position, the fence allows users to simply input onto a keypad or touchscreen a desired width of a wooden board that is to be cut, and then watch the device move accurately into the correct position. This allows craftsmen to work significantly faster when they need to make successive cuts of differing widths. It also helps them avoid mistakes from cutting incorrectly, which wastes time and valuable wood.

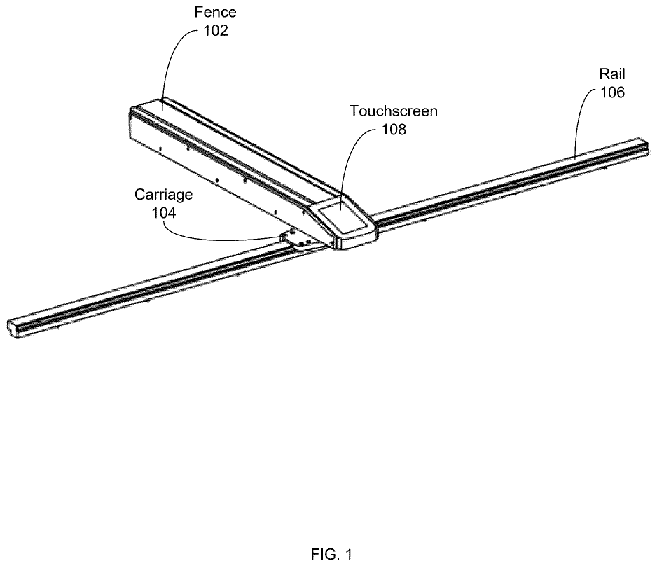

FIG. 1 is an illustration of a front perspective view of an automated table saw fence retrofit system. The system may comprise fence 102, carriage 104, and rail 106. Fence 102 may be elongate and rectangular in shape, and configured to move laterally along a width of a table saw. Fence 102 may be travel, or slide, along rail 106 through wheels of one or more tensioner blocks of carriage 104. A control system may include a computer to actuate a motor, disposed within a front end of fence 102 to move the carriage-fence assembly along rail 106. A touchscreen 108, or any other input device, may be mounted on the front end of fence 102, and may be configured to receive inputs from a user to control the motor through the control system. The motor, such as, e.g., a stepper motor, may include a self-correcting locking mechanism. The system may determine the location of fence 102 upon the number of rotations of the stepper motor, and may be able to detect when fence 102 is inadvertently moved from a predetermined position, such as, e.g., the user accidentally bumping into fence 102. The stepper motor may then activate to move the fence back to the predetermined position without user intervention. In some cases, a positional sensor may be provided on the front end of fence 102 for determining the lateral position of fence 102 along the width of the table.

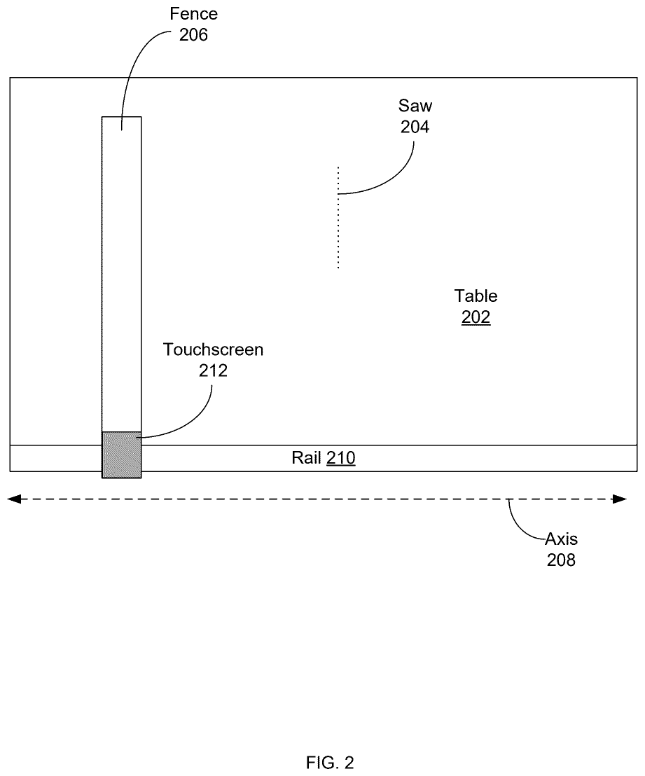

FIG. 2 is a schematic diagram of a top view of an automated table saw fence retrofit system, shown with its intended operational environment. Table 202 may comprise a rectangular top surface that has an opening, in a generally middle portion, through which saw 204 may be positioned. Saw 204 may comprise a circular cutting blade used to cut wood, plastic, metal, composite, or other material. Fence 206 may be generally elongate and rectangular, and is positioned along table 202's depth. For example, fence 206 may extend from a side of table 202 nearest a user to a side furthest from the user, and is oriented to be generally parallel to a cutting plane of saw 204. A front end of fence 206 may engage a front end of table 202.

A carriage may be attached to an underside of fence 206, and is configured to move along a lateral axis 208 of table 202, i.e., left and right. The movement of fence 206 is accomplished along rail 210 by a motor that turns a pinion gear, which spins along a rack attached to a rear face of rail 210. The pinion gear may be of any type, such as, e.g., helical gear, rear rack, spur gear, worm gear, bevel gear, miter gear, or screw gear. The carriage may be connected to rail 210 through wheels of one or more tensioner blocks disposed on a front and/or rear face of the rack. Each tensioner block may be disposed within a front and/or rear face of the carriage. Rail 210 may be elongate and horizontally oriented on a front edge of table 202. The pinion may directly engage the rack without an intermediary device or structure. The motor turns the pinion a predetermined number of revolutions based on a user's entry onto touchscreen 212, and in turn moves the wheels, thereby effectively sliding fence 206 along the front edge of table 202.

Touchscreen 212 may be an input device configured to receive commands from the user, and may be communicatively coupled to a controller that instructs the motor to activate or deactivate.

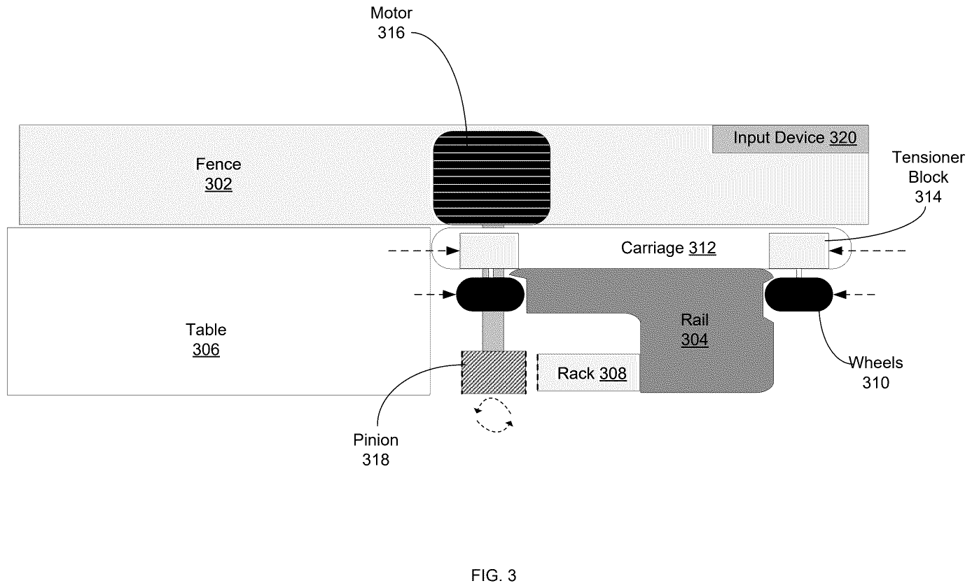

FIG. 3 is a schematic diagram of a cut-away side view of an automated table saw fence retrofit system. The system comprises fence 302 and rail 304. An adapter (not shown), such as, e.g., an angle bracket, may be used as an intermediate component for fixing rail 304 to table 306. Rack 308 attaches to rail 304 on its rear-face, and wheels 310 ride within the grooves in the front and rear faces of rail 304. Rack 308 may be disposed within a lower recessed portion of rail 304 that is covered at the top to limit dust build-up, and open at the bottom to allow for dust extraction, such as, e.g., with a blower. Fence 302 mounts to the rail 304 through carriage 312 and rides along it during normal operation. Carriage 312 may be substantially rectangular in size, oriented perpendicular to fence 302, and parallel to rail 304.

One or more tensioner block 314 may be disposed within a front and/or a rear face of carriage 312. For example, a couple of tensioner block 314 may be positioned within outer edges of carriage 312 on both opposing sides that are in-line with rail 304 One or more sets of wheels 310 may be attached to a bottom portion of each tensioner block 314, below carriage 312. During set up, or retrofitting of table 306, the user may tighten a fastener, such as, e.g., a bolt, of each tensioner block 314 such that it binds to, or moves towards, the center of carriage 312, and thereby allowing wheels 310 to physically engage the grooves of rail 304. The user may further tighten each tensioner block 314 as wheels 310 wear from usage, which may loosen their grip on the grooves. Motor 316 may be disposed within a front edge of fence 302, and may drive pinion 318 through a shaft that extends through an opening of carriage 312. Pinion 318 in turn rotates along rack 308 thereby moving fence 302 along a lateral axis, e.g., from left to right, and vice versa, of table 306. For example, when pinion 318 rotates in one direction, the fence 302 may move in the corresponding direction; and when pinion 318 rotates in the opposite direction, fence 302 may move in the other, corresponding direction. Both rack 308 and pinion 318 may comprise helical teeth, allowing them to engage. An input device 320, such as, e.g., a touchpad, touchscreen, or keypad may be positioned on the front edge of fence 302, and used to input commands or data from the user to a computing device of motor 316. In some cases, motor 316 may include a passive braking mechanism which prevents the fence from moving in event of a power failure. For example, if fence 302 inadvertently moved, and suddenly there was no pressure on a piece of wood being cut, it could result in a “kickback” event that may shoot the piece of wood toward the user, potentially causing harm or injury. The passive braking mechanism may be deactivated with electrical power. In some cases, the passive braking mechanism may be release when the fence is moved, such as, e.g., the brake is engaged until and unless the fence is being repositioned, even when the system is electrically powered.

The system comprising rail 304, rack 308, wheels 310, carriage 312, tensioner block 314, motor 316, pinion 318, and input device 320 may extend beyond an edge of table 306 closest to the user during normal operation. The system may be separate from table 306, and may be retrofitted onto a standard stationary table saw.

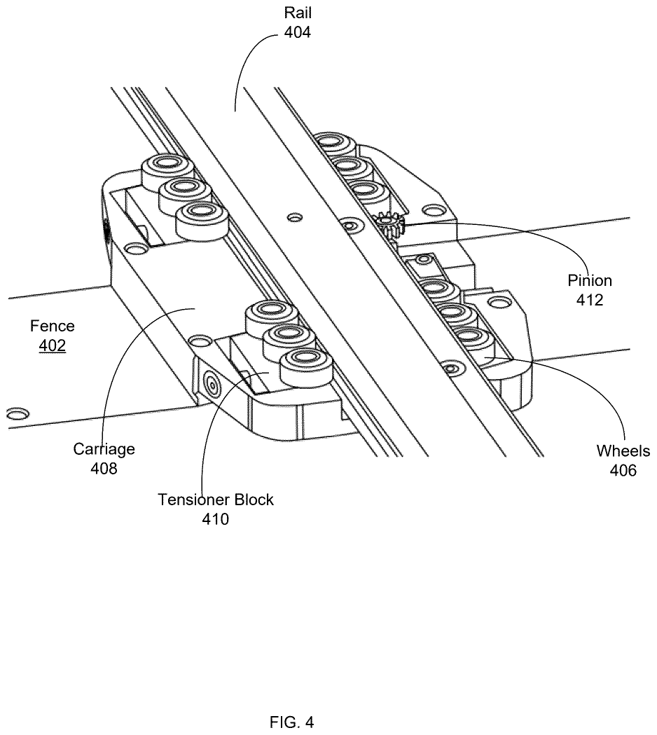

FIG. 4 is an illustration of a bottom view of an automated table saw fence retrofit system. The system comprises fence 402 and rail 404. An adapter (not shown), such as, e.g., an angle bracket, may be used as an intermediate component for fixing rail 404 to a table saw. A rack (not shown) attaches to rail 404 on its rear-face, and wheels 406 ride within grooves in the front and rear faces of rail 404. The rack may be disposed within a lower recessed portion of rail 404 that is covered at the top to limit dust build-up, and open at the bottom to allow for dust extraction, such as, e.g., with a blower. Fence 402 mounts to rail 404 through carriage 408 and rides along it during normal operation. Carriage 408 may be substantially rectangular in size, oriented perpendicular to fence 402, and parallel to rail 404.

One or more tensioner block 410 may be disposed within a front and/or a rear face of carriage 408. For example, a couple of pairs of tensioner block 410 may be positioned within outer edges of carriage 408 on both opposing sides that are in-line with rail 404. One or more sets of wheels 406 may be attached to a bottom portion of each tensioner block 410, below carriage 408. During set up, or retrofitting of the table saw, the user may tighten a fastener, such as, e.g., a bolt, of each tensioner block 410 such that it binds to, or moves towards, the center of carriage 408, and thereby allowing wheels 406 to physically engage the grooves of rail 404. The user may further tighten each tensioner block 410 as wheels 406 wear from usage, which may loosen their grip on the grooves. A motor (not shown) may be disposed within a front edge of fence 402, and may drive pinion 412 through a shaft that extends through an opening of carriage 408. Pinion 412 in turn rotates along the rack thereby moving fence 402 along a lateral axis, e.g., from left to right, and vice versa, of a table saw. For example, when pinion 412 rotates in one direction, the fence 402 may move in the corresponding direction; and when pinion 412 rotates in the opposite direction, fence 402 may move in the other, corresponding direction. Both of the rack and pinion 412 may comprise helical teeth, allowing them to engage. An input device (not shown), such as, e.g., a touchpad, touchscreen, or keypad may be positioned on the front edge of fence 402, and used to input commands or data from the user to a computing device of the motor. In some cases, the motor may include a passive braking mechanism which prevents the fence from moving in event of a power failure. For example, if fence 402 inadvertently moved, and suddenly there was no pressure on a piece of wood being cut, it could result in a “kickback” event that may shoot the piece of wood toward the user, potentially causing harm or injury. The passive braking mechanism may be deactivated with electrical power.

The system comprising rail 404, the rack, wheels 406, carriage 408, tensioner block 410, the motor, pinion 412, and the input device may extend beyond an edge of the table saw closest to the user during normal operation. The system may be separate from the table saw, and may be retrofitted onto a standard stationary table saw.

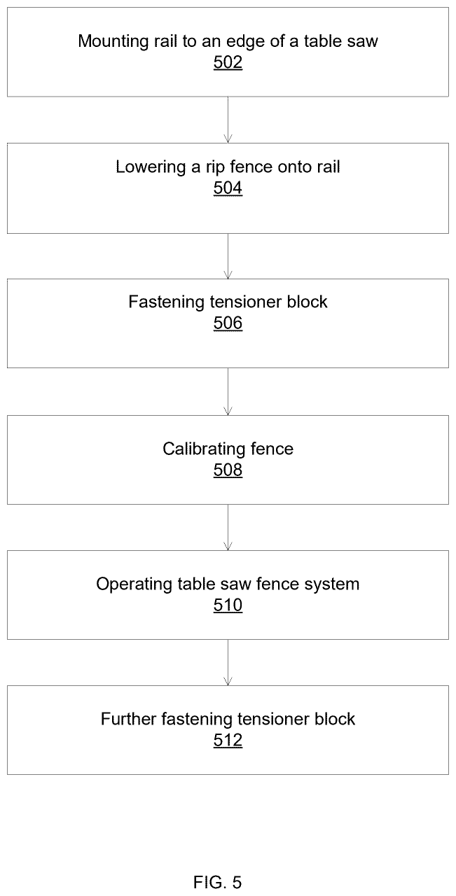

FIG. 5 is a flowchart of a method for retrofitting a table saw fence. Operation 502 mounts a guide rail to an edge closest to a user during normal operation of a table saw. The table saw may comprise a base, a rectangular top surface, and a circular saw blade protruding from a generally middle portion of the top surface. One or more adapters, such as, e.g., an angle bracket, may be used to fix the guide rail to the table saw. Operation 504 lowers a rip fence onto the rail. One or more tensioner blocks attached to the rip fence may be in a loosened state. Wheels emanating from a lower portion of each tensioner block may be positioned on a front and/or rear face of the rail. Operation 506 fastens each tensioner block such that its wheels physically engage grooves of a front and/or rear face of the rail. For example, the user may tighten one or more screws or bolts of each tensioner block, causing the tensioner and wheels to effectively squeeze together, like a vice, against the grooves of the rail. The fence is then pulled into a near-perfect perpendicular alignment with the rail. Operation 508 calibrates the rip fence. For example, the user may input an “auto-calibrate” button on an input device, such as, e.g., a touchscreen or keypad. The fence will then move towards the circular saw and touches it lightly, then backs off slightly, e.g., one inch. A stepper motor of the fence may sense this touch, and a control unit senses that signal to infer the location of “0”. Thereafter, the control unit registers its position based on step counting. Operation 510 operates the table saw fence system. For example, a user may set a desired wood dimension, and then cut a piece of wood by sliding it against a side of the fence closest to the circular saw blade from a front portion of the fence towards its rear without disengaging from the fence until the wood is completely split. Operation 512 further fastens the tensioner blocks as the wheels wear out due to repeated usage from operation 510. Worn out wheels may not engage the grooves of the rail as tightly.

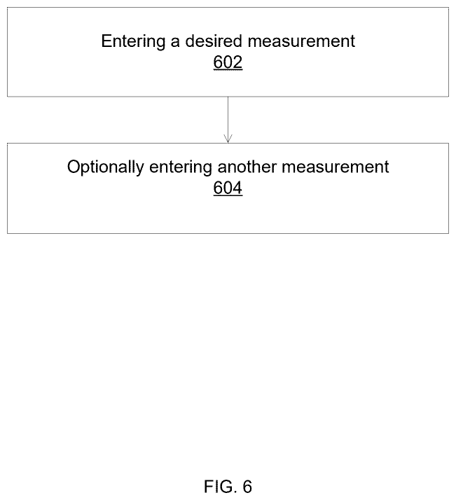

FIG. 6 is a flowchart of a method for operating a table saw fence. Operation 602 enters a desired measurement onto an input device, such as, e.g., a touchscreen or keypad. The table saw fence may then move into position according to the input. Clamping the fence manually is not necessary. A user may then make a desired cut of a piece of wood. Operation 604 optionally enters another desired measurement before the fence move into position again, and then the user makes another cut of the same piece of wood, or a different piece of wood.

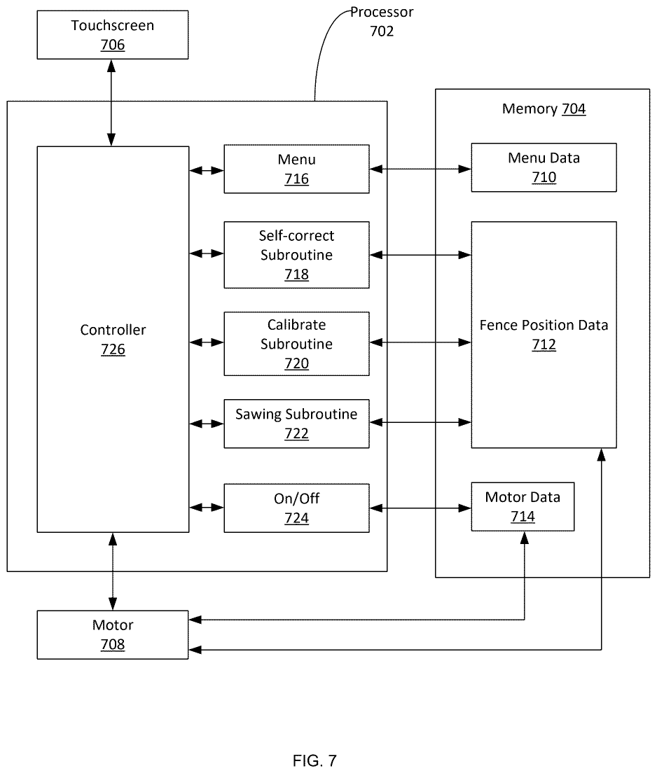

FIG. 7 is a schematic diagram of a table saw fence control system. The system includes a processor 702 communicatively coupled with memory 704, touchscreen 706, and motor 708. Memory 704 includes menu data 710 that is used to produce the menu items within a graphical user interface, fence position data 712 that is determined from signals emanating from motor 708 which that indicate the number of steps motor 708 has taken, and motor data 714 that indicates whether the motor 708 is on or off. Processor 702 includes menu 716, self-correct subroutine 718, calibrate subroutine 720, sawing subroutine 722, and on/off 724. The self-correct subroutine 718 is used by controller 726 to automatically correct the position of a table fence in an event of inadvertently bumping and moving from its desired position. Calibrate subroutine 720 may be used by controller 726 in conjunction with menu 716 to set the table saw fence to the zero position adjacent a saw blade. Sawing subroutine 722 may be used by controller 726 in conjunction with menu 716 to set the table saw fence at a desired location for sawing a workpiece. On/off 724 may be used in conjunction with an input device to turn the motor on or off. Controller 726 may actuate motor 708 to move a table saw fence along a rail, and may transmit signals to touchscreen 706, such as, e.g., to produce the various menu items. Touchscreen 706 may be mounted on a front edge of the fence. In turn, controller 726 may receive signals from touchscreen 706, such as, e.g., from the input device operated by a user.

A number of examples have been described. Nevertheless, it will be understood that various modifications may be made without departing from the spirit and scope of the claimed invention. In addition, the logic flows depicted in the figures do not require the particular order shown, or sequential order, to achieve desirable results. Other steps may be provided, or steps may be eliminated, from the described flows, and other components may be added or removed. Accordingly, other examples are within the scope of the following claims.

What is claimed is:

1. A system, comprising:
a substantially rectangular and elongate fence;
a rail fixed in position at a front edge of a table saw and spanning a length of the table saw;
a carriage physically connected to, and disposed on an underside of, the fence,
wherein the carriage comprises one or more tensioner blocks disposed within one or more lower outer edges, and configured to secure the fence to the rail through clamping of the rail by at least one wheel of the one or more tensioner blocks;
a motor disposed within a front portion of the fence;
a control system disposed within the front portion of the fence configured to actuate the motor configured to turn a pinion gear through a shaft that extends through an opening of the carriage, and
wherein the pinion gear is configured to spin along corresponding teeth of a rack connected to the rail thereby moving the fence along the rail laterally along the length of the table saw.

2. The system of claim 1,
wherein the control system is configured to determine a distance traveled by the fence.

3. The system of claim 2,
wherein the control system is configured to correct the distance traveled by the fence when it does not match a predetermined travel distance.

4. The system of claim 1,
wherein the carriage comprises a pair of tensioner blocks on each of two opposing sides of the rail

5. The system of claim 4,
wherein each tensioner block comprises three wheels

6. The system of claim 1,
wherein the one or more tensioner blocks is disposed within a front face of the carriage.

7. The system of claim 1,
wherein the one or more tensioner blocks is disposed within a rear face of the carriage.

8. The system of claim 1,
wherein the rack attached to a rear-face of the rail.

9. The system of claim 1,
wherein the one or more wheels contact an open groove within a front face of the rail.

10. The system of claim 1,
wherein the one or more wheels contact an open groove within a rear face of the rail.

11. The system of claim 1,
wherein the rack is disposed within a lower recessed portion of the rail.

12. The system of claim 1,
wherein a top portion of the rack is covered from environmental debris.

13. The system of claim 1,
wherein the carriage is substantially rectangular.

14. The system of claim 1,
wherein the carriage is oriented perpendicular to the fence and parallel to the rail.

15. The system of claim 1,
wherein the one or more wheel is connected to a bottom portion of each tensioner block.

16. The system of claim 1,
wherein the motor comprises a braking mechanism for preventing the fence from moving during an electrical power failure event.

17. The system of claim 16,
wherein the braking mechanism is deactivated when the system has electrical power.

18. The system of claim 1,
wherein the rail, rack, carriage, the one or more tensioner blocks, the at least one wheel, motor, pinion, and control system are disposed beyond the front edge of the table saw.
